(19) United States
(12) Patent Application Publication
(10) Pub. No.: US 2012/0309214 A1
(43) Pub. Date: Dec. 6, 2012

(54) AIRCRAFT POWER RECEPTACLE PROTECTION SYSTEM

(76) Inventor: James Beluse, Halton Hills (CA)

(21) Appl. No.: 13/152,695

(22) Filed: Jun. 3, 2011

(51) Int. Cl. H01R 13/62; H01R 3/00

(52) U.S. Cl. 439/180; 439/489; 439/490

(57) ABSTRACT

An aircraft power receptacle protection system is disclosed to protect aircraft from damage from a connected ground power unit. One aspect of the system includes a cable for conducting electricity between a ground power unit and an aircraft that has one or more releasable breakaways that are configured to separate with a determined amount of force. The releasable breakaways are installed inline with the cable and are positioned near the aircraft. The releasable breakaway is light weight and small but is still capable of carrying the required current to the aircraft. Another aspect of the system includes an alarm system for the ground power unit that uses an alarm indicator to alert an operator that the ground power unit is connected to the aircraft. The alarm system can have a aircraft plug with a split connector having to electrically isolated contacts that are connected when the plug is connected to the aircraft receptacle.

### FIELD

The present disclosure relates generally to aircraft systems, and more particularly to protecting aircraft from damage from a connected ground power unit.

### BACKGROUND

A ground power unit or GPU produces electricity suitable for aircraft use while the aircraft is situated on the ground that allows operators to shut down the aircraft's on-board power supply unit (APU). The GPU is used during passenger loading/unloading, servicing, maintenance or other ground support operations. A portable GPU uses a gas or diesel engine mounted on a trailer to drive a generator for producing aircraft grade power. Typically, a tow vehicle is used to move the portable GPU to and from aircraft and for refueling the GPU. The tow vehicle can be a multipurpose vehicle, such as a bag tractor or pickup truck that can also be used to tow any type of trailer around an airport. The GPU can also be a solid state converter in a fixed location, and may convert 60 Hz power supplied from the electrical grid to 400 Hz, 3 phase power at 115 Volts AC and/or 28.5 Volts DC.

The GPU connects to the aircraft through a large, heavy, flexible cable with a plug on the end that fits firmly into a power receptacle which is usually located on the underside of the aircraft fuselage. The cable is composed of two or more large gauge wires that would typically require over 10,000 pounds of force to break the cable. The cable is connected to the aircraft by either an AC or DC military specification aircraft plug to the aircraft's receptacle.

Incidents where the GPU or aircraft inadvertently pull away without unplugging the cable from the receptacle are not uncommon in the airline industry. Due to the strength of the cable, these incidents can result in significant damage to the aircraft, the GPU, and is a safety hazard to nearby personnel. In some cases the receptacle can be completely torn out of the aircraft resulting in damage to the receptacle, bending bulkheads within the aircraft where the receptacle was mounted, denting or tearing of the aircraft skin, and tearing wiring from the aircraft. This damage can ground the aircraft for weeks and can be particularly costly if the aircraft has already been loaded with passengers or cargo. In a loud and busy airport environment a damaged receptacle or dangling GPU power cable may not be detected resulting in greater risk as the aircraft takes flight.

The GPU is also subject to similar damage from these incidents, such as tearing out the generator wiring harness and damage to the fenders, running gear and body of the GPU. The cable itself is typically destroyed in these incidents and can also cause damage to other nearby equipment and injury to nearby personnel. In some cases the tow vehicle can reach its maximum speed of about 18 miles per hour before all the slack is remove from the cable that result in the cable having a whiplash effect when it breaks loose creating another risk of injury or damage.

Current approaches to eliminate the damage from these drive-away incidents is to use a breakaway located at the GPU using the same standard aircraft plugs that are used at the aircraft receptacle. One problem with this approach is that due to the weight and difficulty in moving the cable, operators tend to leave as much cable on the GPU storage reel or storage box as possible using just enough to reach the aircraft. As a result, if the GPU or aircraft is driven away without unplugging it, the cable usually hooks onto another object before the remaining cable is pulled from the GPU and the breakaway plug is reached. Another problem with this approach is that standard aircraft plugs used in the industry are very large, expensive and heavy. It is not practical to install them anywhere else along the cable as it would be too heavy for operators to maneuver the cable.

Another approach, described in U.S. Pat. No. 7,484,689, uses an automatic release mechanism that is triggered by tension in the cable. A rotatable mount structure for the connectors is described that attempts to align a straight push-pull connection and release mechanism with the direction of tension in the cable. This approach is also subject to problems described above with a breakaway placed at the GPU and uses heavy, standard aircraft connectors. Another problem with this approach is that the rotatable mount only aligns tension in the cable in a limited plane of movement whereas the tension could come from any direction, especially at the aircraft receptacle. It is also not practical to install a rotatable mount on the aircraft itself.

U.S. Pat. No. 6,984,625 describes an approach that provides an audio and visual alarm to alert an operator not to tow the GPU unless the plug for the aircraft receptacle is placed in a holster on the GPU. A switch on the GPU senses the position of the tow bar on the GPU and another switch senses when a cable is in the holster attached to the GPU in order to trigger a horn and strobe light power by the on-board GPU battery. This approach does not detect whether the GPU is connected to the aircraft but relies on operator procedure to place the aircraft plug in the holster. This is costly as it requires additional operator procedure and training and an additional holster on the GPU. This system also creates more work for the operators as the cable needs to be replaced in a very specific way (i.e. plugged into the holster). This creates an incentive for the operators to defeat the holster switch with a foreign object rendering the entire warning system inoperative. Warning systems will not protect the aircraft should an operator not recognize the warning and the GPU can still be driven away resulting in aircraft damage.

### SUMMARY

Accordingly there is a need to prevent damage and injury from inadvertent pull away incidents where the GPU is connected to the aircraft.

According to a first aspect, a ground power unit cable is provided for conducting electricity between a ground power unit and an aircraft. The cable has a standard military specification aircraft plug for inserting into an aircraft power receptacle; a releasable breakaway having a first mated connector and a second complimentary mated connector, the connectors configured to separate with a determined tension on the cable; a first insulated wire connecting the aircraft plug to the first mated connector of the releasable breakaway, the first insulated wire having a length to position the breakaway near the aircraft to allow the releasable breakaway to align with tension in the cable; and a second insulated wire connecting to the second mated connector. In a related aspect, the first mated connector has a flag affixed thereto and a portion of the flag is coupled to the second mated connector to release the flag when the releasable breakaway separates. In another related aspect, the aircraft plug has a split connector having two electrically isolated contacts wherein inserting the aircraft plug connects the two electrically isolated contacts. In yet another aspect, the cable has a handle located near the releasable breakaway, the handle having a flexible strap having two end portions, each end portion attached to the cable.

According to a second aspect, an alarm system for preventing damage from a ground power unit is provided. The alarm system has an alarm indicator, an aircraft sensing connector for receiving a signal indicating that the ground power unit is coupled to the aircraft, and a control module connected to the alarm indicator and the aircraft sensing connector, the control module configured to activate the alarm indicator based on the aircraft sensing connector. In a related aspect, the aircraft sensing connector of the alarm system has two electrically isolated contacts that are electrically connected when the ground power unit is coupled to the aircraft. In a further aspect, the aircraft sensing connector can be an aircraft plug having a split connector having the two electrically isolated contacts. In yet another aspect, the alarm system further includes a cable having a first insulated wire connected to a first contact of the two electrically isolated contacts and a second insulated wire connected to a second contact of the two electrically isolated contacts. In another aspect, the alarm system can further include a tow bar sensor connected to the control module wherein the control module is configured to activate the alarm indicator based on both the tow bar sensor and aircraft sensing connector, such as when the tow bar sensor indicates that a tow bar is moved from a non-towing position and aircraft sensing signal connector indicates the ground power unit is connected to the aircraft.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a perspective view of a ground power supply unit connected to an aircraft;

FIG. 2 is a perspective view of an embodiment of a cable used for connecting a GPU with an aircraft with the releasable breakaway connectors and handle installed;

FIG. 3 is a partial cross-sectional view of an embodiment of a releasable breakaway having a male mated connector and a female mated connector;

FIG. 4 is a partial cross-sectional view of an embodiment of a releasable breakaway having a flag affixed to a female mated connector that is coupled to male mated connector;

FIG. 5 is an embodiment of a cable connected to an aircraft at an aircraft receptacle illustrating separated releasable breakaway connectors with a flag deployed;

FIG. 6 is a block diagram of a GPU alarm system for preventing inadvertent pull away incidents while an aircraft sensing connector is attached to aircraft receptacle; and

FIG. 7 is a circuit diagram of an embodiment of a low cost control module that can be used in a GPU alarm system to activate an alarm indicator.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

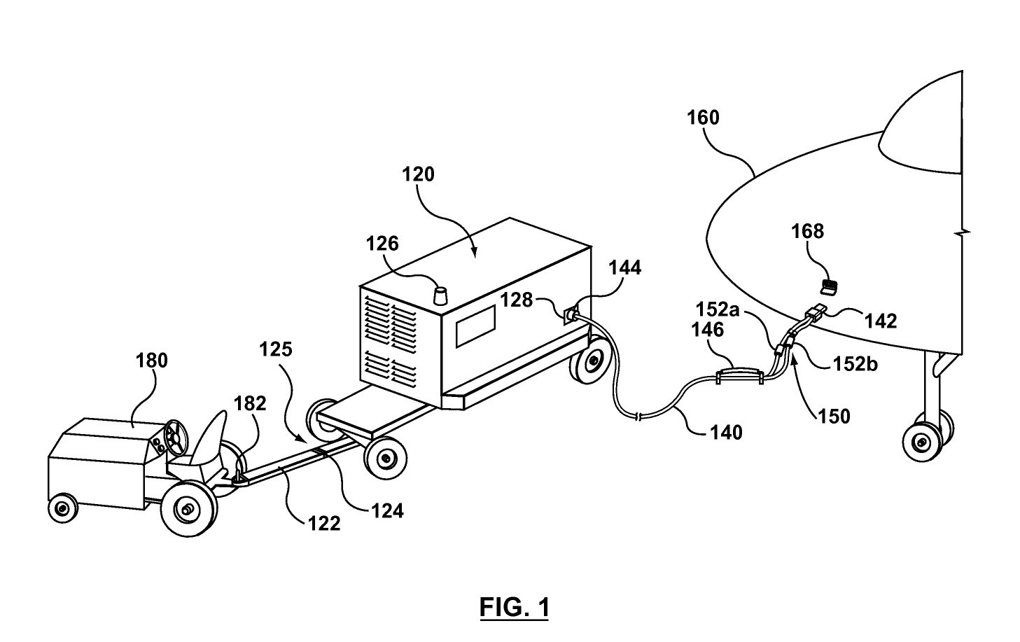

Reference is first made to FIG. 1, shown is a perspective view of a ground power unit (GPU) 120 connected by a ground power unit cable 140 to provide power to an aircraft 160. GPU 120 can be a mobile trailer having an onboard gas or diesel generator that provides power to aircraft 160 through cable 140. GPU 120 produces electricity suitable for aircraft use while aircraft 160 is on the ground to allow operators to shut down the power unit (APU) within aircraft 160. GPU 120 can generate either AC or DC power, such as for example, 400 Hz, 3 phase, 115 Volts AC to neutral or 28.5 Volts DC.

Other embodiments of GPU 120 can be immobile. For example, some types of GPUs use a stationary electric power source, such as from the electric or a stationary generator, that provides power to aircraft 160. Stationary GPUs are typically used at an aircraft loading bridge or in an aircraft hangar.

A tow vehicle 180 can be used to move GPU 120 to and from aircraft and for refueling the generator of GPU 120. Tow vehicle 180 can be a standard bag tractor used in an airport environment or a pick up truck. Tow vehicle 180 includes a hitch 182 to which a towbar 122 can be removably attached. Towbar 122 is connected by a hinge 124 to GPU 120 to allow towbar 122 to be raised and lowered as needed.

The alarm system uses inputs from both towbar switch 125 and aircraft sensing plug 142. If the GPU 120 is connected to the aircraft 160, the towbar 122 is raised engaging the GPU's braking system as well as activating the towbar switch 125. With the towbar 122 is the raised position, it is impossible to tow the GPU 120 away from the aircraft 160 protecting it from damage. When the towbar 122 is lowered to attach to a tow vehicle 180, the towbar switch is deactivated. If the aircraft sensing plug 142 is inserted into the aircraft receptacle 168 a signal is sent through the cable 140 to the GPU 120 activating the alarm indicators 126. Alarm indicator 126 can include a visual alarm (e.g. a commercial off the shelf strobe beacon) and/or an audible alarm (e.g. a commercial off the shelf 95 dB pulsing alarm). An audible alarm can be located lower on GPU 120 and oriented towards towbar 122 to be audible by an operator moving towbar 122. Alarm indicator 126 can be used to alert operators of GPU 120 to avoid a potential pull-away incident where either aircraft 160 or GPU 120 inadvertently pull away before cable 140 has been unplugged from aircraft 160. A pull-away incident could injure personnel or damage GPU 120, cable 140, aircraft 160, or other nearby equipment.

Cable 140 connects between a GPU receptacle 128 and an aircraft receptacle 168 to deliver power to aircraft 160 through cable 140 that is composed of a number of large, insulated, flexible wires. In other embodiments, GPU 120 may not include a GPU receptacle 128 and cable 140 can be connected directly to GPU 120. For example, a cable to connect to an AC aircraft the receptacle is rated at 90 KVA (260 Amps) needs at least 4 wires for the ABC and Neutral, and the wires are typically 2/0 in size but could be as small as 1/0 for lower rated GPUs or as large as 4/0 for special applications. Cable 140 can also include smaller gauge signal wires that can be easily broken in an inadvertent pull away incident. For example, a typical AC cable includes two 12 gauge signal wires (labeled E/F) which are easily broken if GPU 120 is driven away and do not require breakaways. For AC aircraft applications, cable 140 is typically between 30 and 50 feet long but can be as long as 200 feet for special applications. On a DC aircraft the receptacle is rated at 600 Amps continuous with short bursts up to 2500 Amps for starting the aircraft. Cable 140 for DC applications requires a wire size of 4/0 but a 2/0 wire can be used for lower power applications, such as with smaller aircraft. Typically, DC cables are between 25 and 50 feet long for GPU's expected to start aircraft.

As a result of being composed of a number of large gauge wires, cable 140 is heavy and burdensome for operators to maneuver. When cable 140 is not in use it is placed within a storage box or reel within GPU 120 or wrapped on wire collecting posts on the exterior of GPU 120. Due to the weight and difficulty of moving cable 140, operators tend to leave as much cable on GPU 120 as possible using just enough to reach aircraft 160. In a GPU pull-away incident, GPU 120 or aircraft 160 can reach a fairly high speed before slack is removed from the cable such that when cable 140 is pulled taut a large amount of force is placed on cable 140 and connectors and potentially causing a large amount of damage.

Cable 140 connects to aircraft receptacle 168 via an aircraft plug 142 that is typically a military specified plug that is standardized across the aircraft industry for AC or DC aircraft. The other end of cable 140 connects to GPU receptacle 128 via GPU plug 144 that can also be a standardized plug similar to aircraft plug 142. In other embodiments, cable 140 can be connected directly to an output contactor on the GPU 120. The standard aircraft plugs are very large, expensive and heavy and it is not practical or functional to install them anywhere else in-line with cable 140 as it would make cable 140 too heavy. For this reason, a standard aircraft plug is not suitable for providing a breakaway release in cable 140. A breakaway release using a standard aircraft plug would use a 6 pound male connector and 6 pound female connector creating a large, heavy square connector located in an area of cable 140 that will typically be dragged along the tarmac or cement, quickly damaging the soft rubber used in the standard aircraft connectors.

A breakaway section 150 of cable 140 comprises a number of releasable breakaways 152a and 152b. DC applications typically use two releasable breakaways and AC applications typically include four releasable breakaways. Cable 140 can include a releasable breakaway for each of the heavy insulated wires that make up the cable. In embodiments that include smaller signal wires, such as an AC cable, these smaller wires do not require breakaways. Cable 140 is designed to include releasable breakaways 152a-b to reduce the damage from inadvertent pull away incidents where either the GPU 120 or aircraft 160 pull away prior to unplugging aircraft plug 142 from aircraft receptacle 168. Releasable breakaways 152a-b each have two complimentary mated connectors that are designed to separate with a determined amount of tension from cable 140.

Placing releasable breakaways 152a-b inline with cable 140 near aircraft plug 142 ensures that the breakaway is exposed in every case providing increased safety and is more effective at reducing the damage from inadvertent pull away incidents than placing the breakaway at the GPU end of the cable using a standard aircraft plug. Breakaways used at the GPU end of the cable tend to be ineffective since operators tend to leave as much of the heavy cable on the GPU as possible using just enough to reach the aircraft. Consequently, the cable can hook onto something before tension is placed on the breakaway which renders a breakaway at the GPU end of the cable ineffective.

Releasable breakaways 152a-b each have one mated connector that is connected by a first insulated wire of cable 140 to aircraft plug 142 and a complimentary mated connector that is connected by a second insulated wire of cable 140 to GPU 120. The first insulated wire connecting the mated connector of a releasable breakaway to aircraft plug 142 is selected with a length to keep releasable breakaways 152a-b near aircraft 160. Using insulated wire between aircraft plug 142 and releasable breakaways 152a-b allows releasable breakaways 152a-b to orient themselves inline with the direction of tension along cable 140 in an inadvertent pull-away incident. Using this length of wire avoids having to use additional hardware to pivot or rotate a plug receptacle on the GPU or aircraft to align the direction of tension along cable 140 with a plug receptacle, such as aircraft receptacle 168.

Since releasable breakaways 152a-b are located at the aircraft end of the cable, they will typically be exposed (e.g. not contained in GPU 120 storage or caught on other airfield equipment) and will pull away from aircraft 160 in a straight line in the direction of pull. This also reduces the whip action of the cable as it is broken away from the aircraft and is much less likely to cause injury to ground handling personnel in the area from a whipping cable.

The length of the first insulated wire is selected to provide the appropriate amount of bend radius without applying too much tension on aircraft receptacle 168 from aircraft plug 142. The bend radius should allow releasable breakaways 152a-b to align with the direction of tension in cable 140 in an inadvertent pull-away incident. Using a more flexible insulated wire can allow the breakaway to be placed closer to the aircraft but is typically not shorter than 12 inches. The length is also typically long enough so that releasable breakaways 152a-b are not resting on the ground so that they are not damaged or risk getting caught on aircraft 160 (and its nearby landing gear) or surrounding equipment. The length is typically not longer than 36 inches. Preferably, the length is around one foot so that the operator can carry the weight from releasable breakaways 152a-b and aircraft plug 142 together without dragging one or the other along the ground. The length of the first insulated wire can be in the range of 12 inches to 24 inches. Cable 140 can further include a handle 146 placed near releasable breakaways 152a-b, typically on GPU 120 side of the cable 140 to assist operators with carrying cable 140.

In order to use an inline breakaway at the aircraft end on cable 140, releasable breakaways 152a-b are constructed to be small and light but are still capable of carrying the current required by the aircraft and meeting the existing ratings of cable 140 and aircraft plug 142. Releasable breakaways 152a-b are constructed to each weigh around 1.3 pounds.

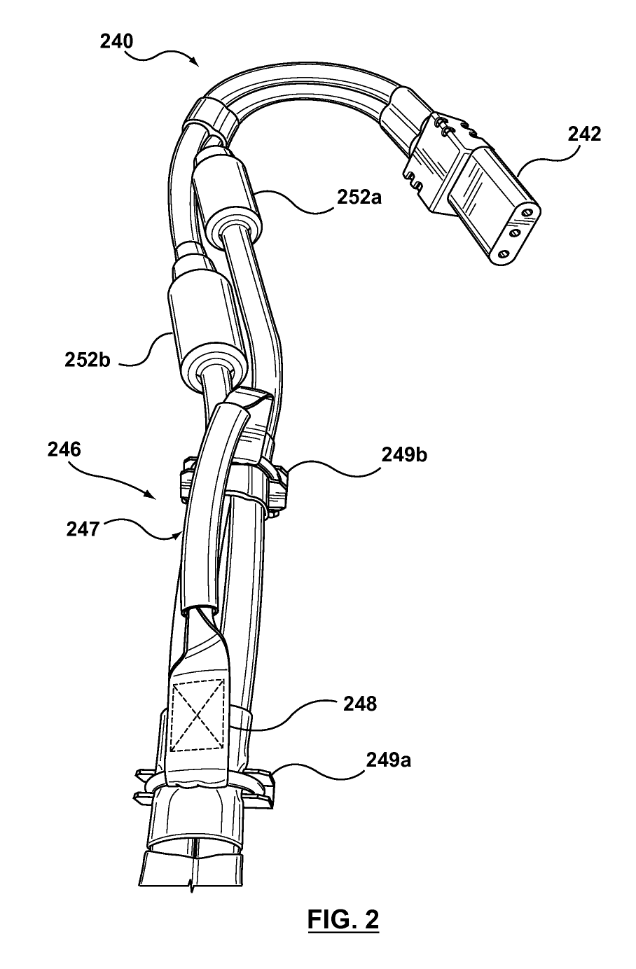

Referring now to FIG. 2, shown is a perspective view of an embodiment of a cable 240 used for connecting a GPU with an aircraft. Aircraft plug 242 and cable 240 are used for providing DC current from a GPU to an aircraft. Releasable breakaway connectors 252a-b are placed inline with cable 240. In some embodiments, releasable breakaways 252a-b can each have the same amount of slack in their connecting insulated wires so that force required to separate cable 240 is the cumulative force of each of releasable breakaway 252a-b. Alternatively, cable 240 can be constructed so that the insulated wires that connect to each of releasable breakaways 252a-b have a different amount of slack so that the releasable breakaways 252a-b separate in an order defined by the tension in the insulated wires (i.e. the releasable breakaways separate sequentially starting with the releasable breakaway with the least amount of slack to most amount of slack). This can be provided as a safety feature so that interlock pins (e.g. AC plug E and F pins on a standard 6 pin connector) release or break first to stop power from the GPU to prevent any arcing between separating connectors.

Handle 246 is constructed of a flexible material 248 that is affixed to cable 240 by attachment mechanisms 249a-b. Flexible material 248 can be constructed of durable cloth or plastic material, such as nylon webbing for example. Attachment mechanisms 249a-b can include adhesives or use mechanical fasteners including but not limited to U-bolts 249a-b shown in FIG. 2. Flexible material 248 can have a handle portion 247 that can comprise a soft rubber tubing to increase grip and surface area of handle 246.

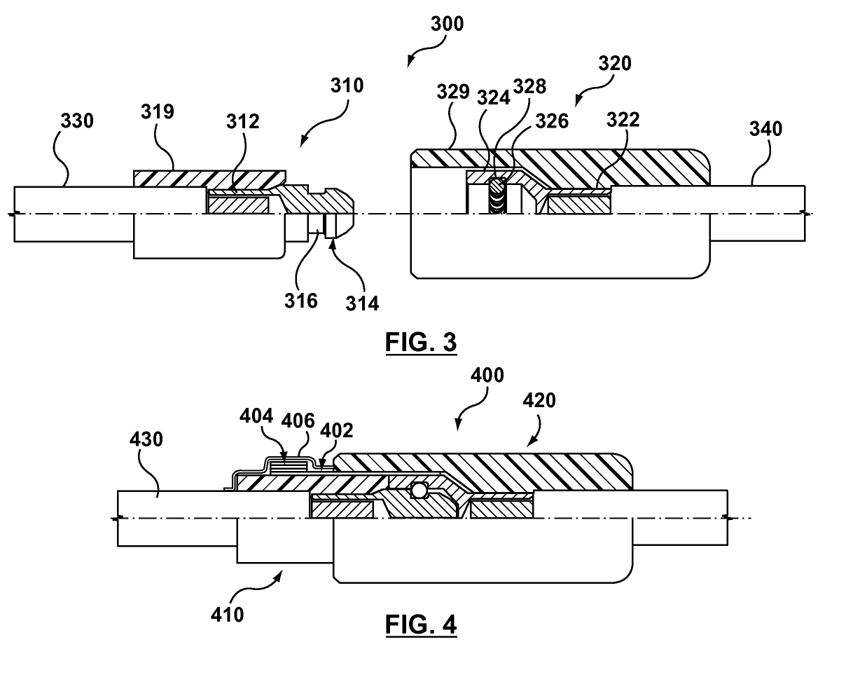

Referring now to FIG. 3, shown is a cross-sectional view of an embodiment of a releasable breakaway 300 having a male mated connector 310 and a female mated connector 320. Both mated connectors have a wire attaching section 312, 322 that attaches the mated connectors to an end portion of insulated wires 330, 340 where the insulation is removed. Male mated connector 310 has a cylindrical male connector 314 with a depression 316 around the outer surface of cylindrical male connector 314. Female mated connector 320 is a hollow cylindrical socket 324 that is shaped to mate with cylindrical male connector 314. Both mated connectors 310, 320 are composed of a highly conductive material, such as a copper alloy contact with silver plating, and mate with a sufficient amount of contact area to meet the power handling requirements of the GPU and aircraft. Latching mechanism 326 extends inwards radially within hollow cylindrical socket 324 to engage depression 316 in cylindrical connector 314. Male mated connector 310 and female mated connector 320 can then be protected with protective shielding 319 and 329, respectively. Protective shielding 319, 329 can be composed of neoprene or other known materials to protect releasable breakaway 300 from mechanical damage and moisture.

Latching mechanism 326 can be a circular latching spring that is seated in groove 328 within hollow cylindrical socket 324. Configuration of the resilience of the latching spring determines the amount of force required to separate mated connectors 310 and 320. The latching spring should be designed to require enough force that releasable breakaway 300 will not separate in regular operation but not require too much force that aircraft receptacle 168 may still be damaged in an inadvertent pull away incident. The force to separate releasable breakaways 300 should be between 20 pounds to 300 pounds, but preferably a force of around 120 pounds can be used. The latching spring makes contact within releasable breakaway 300 to allow for very high current carrying capabilities while keeping the physical size of the connector very small.

Referring now to FIG. 4, shown is a cross-sectional view of an embodiment of a releasable breakaway 400 having a flag 402 affixed to female mated connector 420 that is coupled to male mated connector 410. When releasable breakaway 400 separates male mated connector 410 will release one end of flag 402 while the other end of flag 402 will remain affixed to female mated connector 420 to deploy flag 402. Flag 402 can be fixedly attached to either male or female mated connectors but is typically affixed to the female mated connector that is coupled with aircraft plug 142 so that flag 402 is visible at the mated connector left hanging from aircraft 160 should releasable breakaway 400 separate. Flag 402 serves as a visual indication that a pull away incident has occurred and allows maintenance staff to assess the airworthiness of aircraft 160. Flag 402 should be produced to be highly visible in an airport environment and can use bright colors, such as orange or red, that provide a warning signal to the ground operators.

The end of flag 402 that is exposed when releasable breakaway 400 separates should be loosely coupled to either the mated connector or insulated wire. Flag 402 is shown wrapped around male mated connector 410 that is then covered with a heat shrink tube to secure flag 402 so that it will only be released when releasable breakaway 400 separates.

Use of heat shrink tube to secure flag 402 also prevents a ground operator from simply reconnecting releasable breakaway 400 to hide evidence that a pull away incident has separated releasable breakaway 400 since flag 402 will remain visible. A visible flag 402 should be an indication to ground operators that an aircraft should be examined for damage prior to flight.

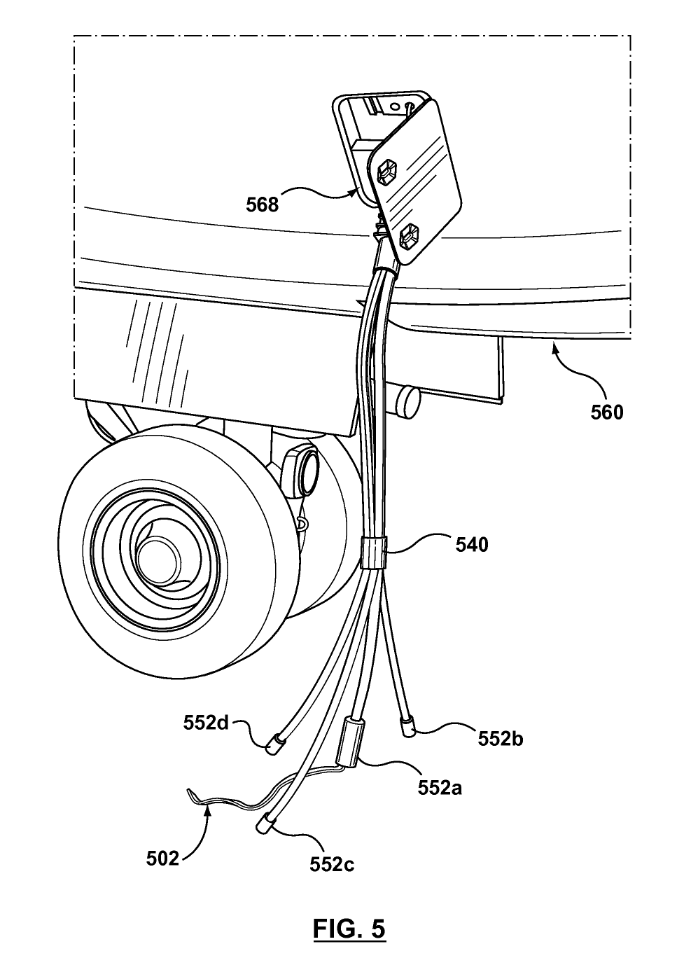

Referring now to FIG. 5, shown is an embodiment of a cable 540 connected to aircraft 560 at aircraft receptacle 568 illustrating separated releasable breakaway connectors 552a-d and a flag 502 deployed. Cable 540 is comprised of four insulated wires that each have a releasable breakaway attached thereto. A mated connector of releasable breakaway 552a is shown with flag 502 attached. Other embodiments may use a flag attached to each releasable breakaway 552a-d to provide additional visibility. Alternative embodiments can have the other mated connectors (i.e. those not depicted in FIG. 5 as they have left with the GPU) include exposed flags.

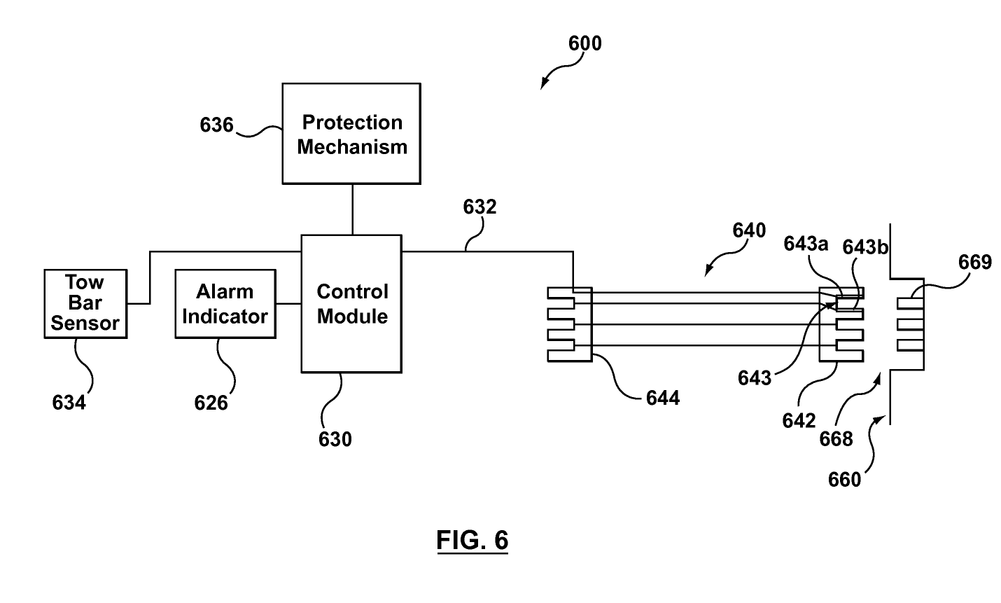

Referring now to FIG. 6, shown is a block diagram of a GPU alarm system 600 for preventing inadvertent pull away incidents while aircraft sensing connector 642 is attached to aircraft receptacle 668 of aircraft 660. GPU alarm system 600 has control module 630 that is connected to an alarm indicator 626 and also receives an aircraft-sensing signal 632 from GPU aircraft sensing connector 642 from cable 640. In some embodiments, GPU connector 644 can be a modified aircraft plug on the end of cable 640 that provides aircraft-sensing signal 632 to control module 630. Although a typical AC cable will include six insulated wires and contact pins/sockets, FIG. 6 only shows three wires, pins and sockets to simplify illustration of GPU alarm system 600.

Aircraft-sensing signal 632 indicates whether aircraft sensing connector 642 is inserted into aircraft receptacle 668. Control module 630 can then activate alarm indicator 626 based on aircraft-sensing signal 632 to alert ground operators or pilots that a GPU is connected to aircraft 660. In a static GPU embodiment, alarm indicator 626 can be a strobe beacon that is visible to the ground operators, pilots, or both to increase awareness of the state of the GPU and aircraft sensing connector 642.

In a mobile GPU embodiment, control module 630 can also be connected to a tow bar sensor 634 that indicates whether the tow bar is in an upright position or a lowered towing position. Control module 630 can then be configured to activate alarm indicator 626 if a ground operator attempts to move the tow bar from a non-towing position (e.g. upright) while aircraft-sensing signal 632 indicates that aircraft sensing connector 642 is still connected to aircraft 660. Alarm indicator 626 can include a strobe beacon and an audible alarm, such as 95 dB pulsing alarm, that is directed towards an operator that may be lowering the tow bar to notify the operator that aircraft sensing connector 642 is still connected to aircraft 660 before the operator has a chance to drive away. Some embodiments can further include a protection mechanism 636 connected to control module 630 that can be engaged to prevent the GPU from being moved if aircraft-sensing signal 632 indicates that aircraft sensing connector 642 is still connected to aircraft 660. For example, protection mechanism 636 can include a tow bar interlock mechanism that locks the tow bar in the upright position until aircraft-sensing signal indicates that aircraft sensing connector 642 has been removed from aircraft 660. Protection mechanism 636 can further control the brakes of the GPU trailer to only release the brakes if both the tow bar is down and aircraft plug is unplugged as indicated by tow bar sensor 634 and aircraft-sensing signal 632.

Aircraft-sensing signal 632 can be generated using split connector 643 of aircraft sensing connector 642 that has two electrically isolated contacts 643a and 643b that are electrically connected when aircraft sensing connector 642 is inserted into aircraft receptacle 668. For example, pin 669 of aircraft receptacle 668 will electrically connect electrically isolated contacts 643a and 643b of split connector 643 when it mates with pin 669. In an embodiment where aircraft sensing connector 642 uses male pin connectors, one of the male pin connectors could be a split connector 643 that includes two electrically isolated contacts separated by an insulator that become electrically connected when inserted into a mating socket. Pin 669 can be the neutral pin of aircraft receptacle 668 or an unused pin that is used to key/orient the connectors. Cable 640 has two insulated wires connected to each of electrically isolated contacts 643a-b one of which acts as the neutral connection to the GPU and the other provides aircraft-sensing signal 632.

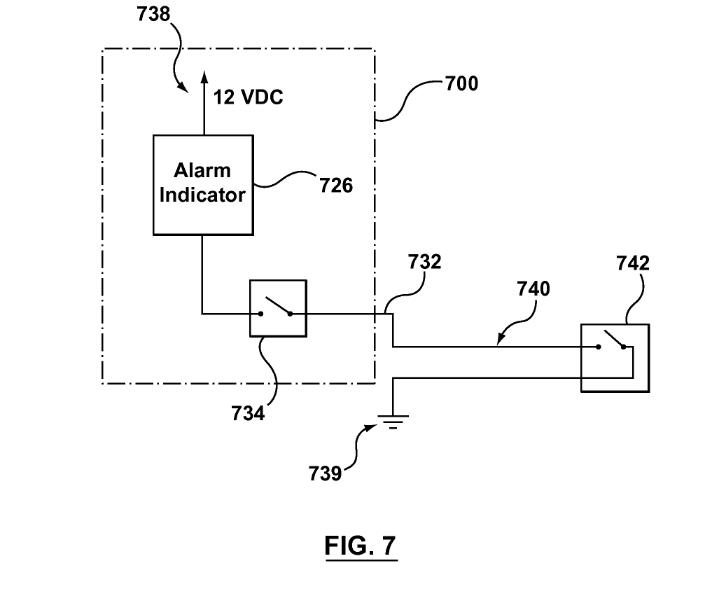

Now referring to FIG. 7, shown is a circuit diagram of an embodiment of a low cost control module 700 that can be used in a GPU alarm system to activate alarm indicator 726 when tow bar switch 734 is closed and aircraft-sensing signal 732 is active (e.g. connected to ground through the aircraft neutral pin). Alarm indicator 726 is connected to power supply 738 that supplies power to control module 700. Power supply 738 can be provided by the GPU's onboard battery that is used to start the engine used to run the generator; typically a lead-acid battery that supplies 12 or 24 Volts DC. When aircraft sensing connector 742 is inserted into an aircraft, aircraft-sensing signal is connected to the ground or neutral connection 739 of the GPU through cable 740. This completes the circuit between power supply 738 and alarm indicator 726 to ground 739 through tow bar switch 734 and aircraft sensing connector 742 that are connected in series.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A ground power unit cable for conducting electricity between a ground power unit and an aircraft, the cable comprising:
an aircraft plug for inserting into an aircraft power receptacle;
a releasable breakaway having a first mated connector and a second complimentary mated connector, the connectors configured to separate with a determined tension on the cable;
a first insulated wire connecting the aircraft plug to the first mated connector of the releasable breakaway, the first insulated wire having a length to position the breakaway near the aircraft to allow the releasable breakaway to align with tension in the cable; and
a second insulated wire connecting to the second mated connector.

2. The cable of claim 1 further comprising a plurality of releasable breakaways, a plurality of first insulated wires and a plurality of second insulated wires, each of the plurality of breakaways having one of the plurality of first insulated wires connected to one of the two mated connectors and one of the plurality of second insulated wires connected to the other of the two mated connectors, and each of the plurality of first insulated wires connected to the aircraft plug.

3. The cable of claim 1 wherein the first insulated wire has a length in a range of 12 inch to 36 inches.

4. The cable of claim 1 wherein one of the first and second mated connectors is a cylindrical male connector having a depression in outer surface and an other of the first and second mated connectors is a hollow cylindrical socket female connector having a latching mechanism that extends inwards radially to engage the depression in the male connector.

5. The cable of claim 4 wherein the latching mechanism is a circular latching spring.

6. The cable of claim 5 wherein the latching spring is configured to define the determined tension that causes the releasable breakaway to separate.

7. The cable of claim 1 wherein the first mated connector has a flag affixed thereto and a portion of the flag is coupled to the second mated connector to release the flag when the releasable breakaway separates.

8. The cable of claim 7 wherein the flag is coupled to the second mated connector with heat shrink tubing.

9. The cable of claim 1 wherein the aircraft plug has a split connector having two electrically isolated contacts wherein inserting the aircraft plug connects the two electrically isolated contacts.

10. The cable of claim 1 further comprising a handle located near the releasable breakaway, the handle comprising a flexible strap having two end portions, each end portion attached to the cable.

11. An alarm system for preventing damage from to an aircraft from a ground power unit, the alarm system comprising:
an alarm indicator;
an aircraft sensing connector for receiving a signal indicating that the ground power unit is coupled to the aircraft; and
a control module connected to the alarm indicator and the aircraft sensing connector, the control module configured to activate the alarm indicator based on the aircraft sensing connector.

12. The alarm system of claim 11 wherein the aircraft sensing connector has two electrically isolated contacts, the two electrically isolated contacts being electrically connected when the ground power unit is coupled to the aircraft.

13. The alarm system of claim 12 wherein the aircraft sensing connector is an aircraft plug having a split connector comprised of the two electrically isolated contacts.

14. The alarm system of claim 13 further comprises:
a cable having:
a first insulated wire connected to a first contact of the two electrically isolated contacts; and
a second insulated wire connected to a second contact of the two electrically isolated contacts.

15. The alarm system of claim 11 further comprising a tow bar sensor connected to the control module, the control module configured to activate the alarm indicator based on the tow bar sensor and aircraft sensing connector.

16. The alarm system of claim 15 wherein the control module is configured to activate the alarm indicator when the tow bar sensor indicates that a tow bar is moved from a non-towing position and aircraft sensing signal connector indicates the ground power unit is connected to the aircraft.

17. The alarm system of claim 11 wherein the control module further comprises a circuit having the aircraft sensing connector, the alarm indicator, and a power supply connected in series such that the circuit is completed when the ground power unit is coupled to the aircraft.

18. The alarm system of claim 17 further comprising a tow bar switch that is closed when a tow bar is in a towing position, wherein the tow bar switch is connected in series with the aircraft sensing connector.

19. The alarm system of claim 11 wherein the alarm indicator is any one of an audio alarm and a visual alarm.

20. The alarm system of claim 19 wherein the audio alarm is a pulsing alarm.

21. The alarm system of claim 19 wherein the visual alarm is a strobe beacon.
